(19) United States
(12) Patent Application Publication
(10) Pub. No.: US 2025/0067845 A1
(43) Pub. Date: Feb. 27, 2025

(54) Apparatus For Recognizing Object And Method Thereof

(71) Applicants: Hyundai Motor Company, Seoul (KR); Kia Corporation, Seoul (KR)

(72) Inventor: Mi Rim Noh, Jeonju-si (KR)

(21) Appl. No.: 18/595,782

(22) Filed: Mar. 5, 2024

(30) Foreign Application Priority Data
Aug. 21, 2023 (KR) 10-2023-0109247

(51) Int. Cl. G01S 7/48; G01S 17/42

(52) U.S. Cl. CPC G01S 7/4802; G01S 17/42

(57) ABSTRACT

The present disclosure relates to an object recognition apparatus and method. The object recognition apparatus includes a sensor (e.g., LIDAR) and a processor. The processor may extract a plurality of representative points, determine a first reference contour point, a first representative point, a second representative point, and a third representative point among the plurality of representative points, determine a first distance between the first reference contour point and the second representative point; determine a first angle between a first ray extending from the first reference contour point to the first representative point and a second ray extending from the second representative point to the third representative point, determine a fourth representative point, and determine, as a contour point, one of the first representative point, the second representative point, or the fourth representative point as the contour point.

### CROSS-REFERENCE TO RELATED APPLICATION

This application claims the benefit of priority to Korean Patent Application No. 10-2023-0109247, filed in the Korean Intellectual Property Office on Aug. 21, 2023, the entire contents of which are incorporated herein by reference.

### TECHNICAL FIELD

The present disclosure relates to an object recognition apparatus and method, and more particularly, to a technique for obtaining a contour point of an object based on a cloud of points obtained through a light detection and ranging (LIDAR) device.

### BACKGROUND

Technology to detect surrounding environments and avoid obstacles is essential for autonomous vehicles.

A vehicle may obtain data indicating the position of an object around the vehicle through a LIDAR. A distance from a LIDAR to an object can be measured based on an interval between the time when laser is transmitted by the LIDAR and the time when the laser reflected off the object is received. A vehicle is able to identify the location of a point included in the object in a space where the vehicle is located, based on the angle of the transmitted laser and the distance to the object.

Data obtained through the LIDAR is characterized by high resolution and a large number of points included in the data. The importance of technology for identifying the shape of an object around a vehicle from the data by efficiently performing computations within limited resources is increasing.

### SUMMARY

The present disclosure has been made to solve the above-mentioned problems occurring in some implementations while advantages achieved by those implementations are maintained intact.

An aspect of the present disclosure provides an object recognition apparatus and method for identifying contour points among a plurality of representative points.

An aspect of the present disclosure provides an object recognition apparatus and method for increasing the accuracy of contour points.

An aspect of the present disclosure provides an object recognition apparatus and method for reducing the amount of computation for identifying contour points.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, an object recognition apparatus may include: a sensor and a processor, The processor may be configured to: extract, among a plurality of points that are obtained via the sensor and represent an object, a plurality of representative points including at least part of surface points of the object; determine a first reference contour point, which is one of two outermost end points of the plurality of representative points; determine a first representative point, which is adjacent to the first reference contour point among the plurality of representative points; determine, among the plurality of representative points, a second representative point different from the first reference contour point; determine a third representative point, which is a point that is, of two representative points on both sides of the second representative point, farther away from the first reference contour point; determine a first distance between the first reference contour point and the second representative point; determine a first angle between a first ray extending from the first reference contour point to the first representative point and a second ray extending from the second representative point to the third representative point; determine, as a contour point, one of: the second representative point, based on the first representative point matching the second representative point, and further based on determining that the first distance is greater than a threshold distance or the first angle is greater than or equal to a threshold angle, one of the first representative point or the second representative point, based on the first representative point not matching the second representative point, further based on determining that the first distance is greater than the threshold distance or the first angle is greater than or equal to the threshold angle, and further based on determining that no other representative point, among the plurality of representative points, exists between the first representative point and the second representative point, or one of the second representative point or a fourth representative point, based on the first representative point not matching the second representative point, further based on determining that at least one other representative point among the plurality of representative points exists between the first representative point and the second representative point, and further based on determining that the first distance is greater than the threshold distance or the first angle is greater than or equal to the threshold angle. The fourth representative point may be a point that is, of the two representative points on both sides of the second representative point, closer to the first reference contour point; and control a vehicle based on the contour point.

The processor may be further configured to determine, as the contour point, one of: the second representative point, based on determining that the first distance is greater than the threshold distance, and further based on the first representative point matching the second representative point, the first representative point, based on determining that the first distance is greater than the threshold distance, and further based on determining that no other representative point exists between the first representative point and the second representative point, or the fourth representative point, based on determining that the first distance is greater than the threshold distance, and further based on determining that the at least one other representative point exists between the first representative point and the second representative point.

The processor may be further configured to determine one of: the second representative point as the contour point based on the second representative point being one of the two outermost end points, and further based on determining that the first distance is less than or equal to the threshold distance and the first angle is less than the threshold angle, or the contour point not existing among the first representative point, the second representative point, and the fourth representative point, based on the second representative point not being one of the two outermost end points.

The processor may be further configured to determine the second representative point as the contour point based on determining that the first distance is less than or equal to the threshold distance and the first angle is greater than or equal to the threshold angle.

The processor may be further configured to determine, as the contour point, one of: the second representative point, based on determining that the second representative point is one of the two outermost end points, further based on determining that the first distance is greater than the threshold distance, and further based on the first representative point not matching the second representative point, the first representative point, based on determining that the second representative point is one of the two outermost end points, further based on determining that the first distance is greater than the threshold distance, further based on the first representative point not matching the second representative point, and further based on determining that there is no other representative point, among the plurality of representative points, exists between the first representative point and the second representative point, or the fourth representative point, based on determining that the second representative point is one of the two outermost end points, further based on determining that the first distance is greater than the threshold distance, further based on the first representative point not matching the second representative point, and further based on determining that at least one other representative point among the plurality of representative points exists between the first representative point and the second representative point.

The processor may be further configured to: determine the second representative point as the contour point based on determining that the second representative point is one of the two outermost end points, and further based on determining that the first distance is less than or equal to the threshold distance.

The processor may be further configured to: determine a fifth representative point, which is a point that is, of two representative points on both sides of the third representative point, farther away from the first reference contour point, based on determining that the contour point does not exist among the first representative point, the second representative point, and the fourth representative point; and determine one of the second representative point or the third representative point as the contour point, based on determining that a second distance between the first reference contour point and the third representative point is greater than the threshold distance or a second angle between the first ray and a third ray extending from the third representative point to the fifth representative point is greater than or equal to the threshold angle.

The processor may be further configured to: determine a second reference contour point and a third reference contour point. The third reference contour point is one of two contour points on both sides of the second reference contour point; determine a sixth representative point that is not between the second reference contour point and the third reference contour point; determine a seventh representative point, which is a point that is, of two representative points on both sides of the sixth representative point, farther away from the second reference contour point; determine a second distance between the third reference contour point and the seventh representative point; determine a second angle between a third ray extending from the second reference contour point to the third reference contour point and a fourth ray extending from the sixth representative point to the seventh representative point; and determine, as the contour point, one of: the seventh representative point, based on determining that the second distance is greater than the threshold distance or the second angle is greater than or equal to the threshold angle, and further based on the third reference contour point matching the sixth representative point; or one of the sixth representative point or the seventh representative point, based on determining that the second distance is greater than the threshold distance or the second angle is greater than or equal to the threshold angle, and further based on the third reference contour point not matching the sixth representative point.

The processor may be further configured to determine, as the contour point, one of: the seventh representative point, based on the second distance being greater than the threshold distance, and further based on the third reference contour point matching the sixth representative point, or the sixth representative point, based on the second distance being greater than the threshold distance, and further based on the third reference contour point not matching the sixth representative point.

The processor may be further configured to: determine whether the seventh representative point is one of the two outermost end points, based on determining that the second distance is less than or equal to the threshold distance and the second angle is less than the threshold angle; and determine one of: the seventh representative point as the contour point, based on the seventh representative point being one of the two outermost end points, or the contour point not existing among the sixth representative point and the seventh representative point, based on the seventh representative point not being one of the two outermost end points.

The processor may be further configured to determine the seventh representative point as the contour point based on determining that the second distance is less than or equal to the threshold distance and the second angle is greater than or equal to the threshold angle.

The processor may be further configured to: determine an eighth representative point, which is a point that is, of two representative points on both sides of the seventh representative point, farther away from the second reference contour point, based on determining that the contour point does not exist among the sixth representative point and the seventh representative point; and determine one of the seventh representative point and the eighth representative point as the contour point, based on determining that a third distance between the third reference contour point and the eighth representative point is greater than the threshold distance or a third angle between the third ray and a fifth ray extending from the seventh representative point to the eighth representative point is greater than or equal to the threshold angle.

According to one or more example embodiments of the present disclosure, an object recognition method may include: extracting, among a plurality of points that are obtained via a sensor and represent an object, a plurality of representative points including at least part of surface points of the object; determining a first reference contour point, which is one of two outermost end points of the plurality of representative points; determining a first representative point, which is adjacent to the first reference contour point among the plurality of representative points; determining, among the plurality of representative points, a second representative point different from the first reference contour point; determining a third representative point, which is a point that is, of two representative points on both sides of the second representative point, farther away from the first reference contour point; determining a first distance between the first reference contour point and the second representative point; determining a first angle between a first ray extending from the first reference contour point to the first representative point and a second ray extending from the second representative point to the third representative point; determining, as a contour point, one of: the second representative point, based on the first representative point matching the second representative point, and further based on determining that the first distance is greater than a threshold distance or the first angle is greater than or equal to a threshold angle, one of the first representative point or the second representative point, based on the first representative point not matching the second representative point, further based on determining that the first distance is greater than the threshold distance or the first angle is greater than or equal to the threshold angle, further based on determining that no other representative point, among the plurality of representative points, exists between the first representative point and the second representative point, or one of the second representative point or a fourth representative point, based on the first representative point not matching the second representative point, further based on determining that at least one other representative point among the plurality of representative points exists between the first representative point and the second representative point, and further based on determining that the first distance is greater than the threshold distance or the first angle is greater than or equal to the threshold angle. The fourth representative point may be a point that is, of the two representative points on both sides of the second representative point, closer to the first reference contour point; and controlling a vehicle based on the contour point.

The object recognition method may further include determining, as the contour point, one of: the second representative point, based on determining that the first distance is greater than the threshold distance, and further based on the first representative point matching the second representative point, the first representative point, based on determining that the first distance is greater than the threshold distance, further based on determining that no other representative point exists between the first representative point and the second representative point, or the fourth representative point, based on determining that the first distance is greater than the threshold distance and further based on determining that the at least one other representative point exists between the first representative point and the second representative point.

The object recognition method may further include determining one of: the second representative point as the contour point based on the second representative point being one of the two outermost end points and further based on determining that the first distance is less than or equal to the threshold distance and the first angle is less than the threshold angle, or the contour point not existing among the first representative point, the second representative point, and the fourth representative point, based on the second representative point not being one of the two outermost end points.

The object recognition method may further include: determining the second representative point as the contour point based on determining that the first distance is less than or equal to the threshold distance and the first angle is greater than or equal to the threshold angle.

The object recognition method may further include determining, as the contour point, one of: the second representative point, based on determining that the second representative point is one of the two outermost end points, further based on determining that the first distance is greater than the threshold distance, and further based on the first representative point matching the second representative point, the first representative point, based on determining that the second representative point is one of the two outermost end points, further based on determining that the first distance is greater than the threshold distance, further based on the first representative point not matching the second representative point, and further based on determining that there is no other representative point, among the plurality of representative points, exists between the first representative point and the second representative point, or the fourth representative point, based on determining that the second representative point is one of the two outermost end points, further based on determining that the first distance is greater than the threshold distance, further based on the first representative point not matching the second representative point, and further based on determining that at least one other representative point among the plurality of representative points exists between the first representative point and the second representative point.

The object recognition method may further include: determining the second representative point as the contour point based on determining that the second representative point is one of the two outermost end points, and further based on determining that the first distance is less than or equal to the threshold distance.

The object recognition method may further include: determining a fifth representative point, which is a point that is, of two representative points on both sides of the third representative point, farther away from the first reference contour point, based on determining that the contour point does not exist among the first representative point, the second representative point, and the fourth representative point; and determining one of the second representative point or the third representative point as the contour point, based on determining that a second distance between the first reference contour point and the third representative point is greater than the threshold distance or a second angle between the first ray and a third ray extending from the third representative point to the fifth representative point is greater than or equal to the threshold angle.

The object recognition method may further include: determining a second reference contour point and a third reference contour point. The third reference contour point may be one of two contour points on both sides of the second reference contour point; determining a sixth representative point that is not between the second reference contour point and the third reference contour point; determining a seventh representative point, which is a point that is, of two representative points on both sides of the sixth representative point, farther away from the second reference contour point; determining a second distance between the third reference contour point and the seventh representative point; determining a second angle between a third ray extending from the second reference contour point to the third reference contour point and a fourth ray extending from the sixth representative point to the seventh representative point; and determining, as the contour point, one of: the seventh representative point, based on determining that the second distance is greater than the threshold distance or the second angle is greater than or equal to the threshold angle, and further based on the third reference contour point matching the sixth representative point; or one of the sixth representative point or the seventh representative point, based on determining that the second distance is greater than the threshold distance or the second angle is greater than or equal to the threshold angle, and further based on the third reference contour point not matching the sixth representative point.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram showing an object recognition apparatus;

FIG. 2 shows an example showing a change in the moving direction of an object identified according to selection of contour points;

FIG. 3 shows a flowchart of operation of an object recognition apparatus for identifying contour points according to a specified angle and a specified distance in the object recognition apparatus or an object recognition method;

FIG. 4 shows a flowchart of operation of the object recognition apparatus for identifying a contour point through one reference contour point in the object recognition apparatus or the object recognition method;

FIG. 5 shows examples of a reference contour point for identifying contour points and identified representative points in an object recognition apparatus or an object recognition method;

FIG. 6 shows a flowchart of operation of the object recognition apparatus for identifying a contour point through one reference contour point in the object recognition apparatus or the object recognition method;

FIG. 7 shows a flowchart of operation of the object recognition apparatus for identifying a specific representative point is a contour point through one reference contour point in the object recognition apparatus or the object recognition method;

FIG. 8 shows examples of a plurality of reference contour points for identifying contour points and identified representative points in an object recognition apparatus or an object recognition method;

FIG. 9 shows a flowchart of operation of the object recognition apparatus for identifying a contour point through a plurality of reference contour points in the object recognition apparatus or the object recognition method;

FIG. 10 shows examples of identified contour points in an object recognition apparatus or an object recognition method;

FIG. 11 shows an example of reliability for indicating the accuracy of identified contour points in an object recognition apparatus or object recognition method; and

FIG. 12 illustrates a computing system for an object recognition apparatus or an object recognition method.

### DETAILED DESCRIPTION

Hereinafter, one or more example embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the example embodiments of the present disclosure, a detailed description of well-known features or functions will be ruled out in order not to unnecessarily obscure the gist of the present disclosure.

In describing the components of the example embodiments of the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

Further, the terms “unit”, “device”, “member”, “body”, or the like used hereinafter may indicate at least one shape structure or may indicate a unit for processing a function.

In addition, in example embodiments of the present disclosure, the expressions “greater than” or “less than” may be used to indicate whether a specific condition is satisfied or fulfilled, but are used only to indicate examples, and do not exclude “greater than or equal to” or “less than or equal to”. A condition indicating “greater than or equal to” may be replaced with “greater than”, a condition indicating “less than or equal to” may be replaced with “less than”, a condition indicating “greater than or equal to and less than” may be replaced with “greater than and less than or equal to”. In addition, ‘A’ to ‘B’ means at least one of elements from A (including A) to B (including B).

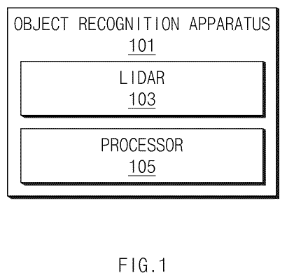

Hereinafter, one or more example embodiments of the present disclosure will be described in detail with reference to FIGS. 1 to 12.

FIG. 1 is a block diagram showing an object recognition apparatus.

Referring to FIG. 1, an object recognition apparatus 101 may be implemented inside a vehicle. In this case, the object recognition apparatus 101 may be integrally formed with internal control units of the vehicle, or may be implemented as a separate device and connected to the control units of the vehicle by separate connection means.

Referring to FIG. 1, the object recognition apparatus 101 may include a sensor (e.g., LIDAR) 103 and a processor 105.

The processor 105 of the object recognition apparatus 101 may obtain location information of points of an object around a vehicle including the object recognition apparatus 101 through the sensor (e.g., LIDAR) 103. The processor 105 of the object recognition apparatus 101 may acquire points representing the object through the sensor (e.g., LIDAR) 103. The points obtained through sensor (e. g., LIDAR) and representing the object may be referred to as a point cloud, but the present disclosure may not be limited thereto.

The processor 105 of the object recognition apparatus 101 may extract a plurality of representative points including some or all of outer points (e.g., surface points) among the points representing the object.

The processor 105 of the object recognition apparatus 101 may identify contour points among the plurality of representative points. The contour points may represent the outer shape of an object. The contour points may include representative points capable of representing the outer shape of the object among the plurality of representative points.

The processor 105 of the object recognition apparatus 101 may obtain information on the object, such as the shape of the object and the direction of movement of the object, through the contour points.

Because an autonomous driving system or driving assistance system need to be able to immediately detect a surrounding environment, the size of a memory available to an object recognition apparatus and an available execution time may be limited. The object recognition apparatus may identify an object within a limited memory size and limited execution time by reducing the number of contour points. This is because the amount of computation to obtain information on the object may decrease as the number of contour points decreases.

However, as the number of contour points decreases, the accuracy of information on the object may decrease. To compensate for reduction in accuracy of information, the processor 105 of the object recognition apparatus 101 may identify efficient contour points capable of representing the shape of the object among the plurality of representative points to improve the accuracy of information on the object.

The processor 105 of the object recognition apparatus 101 may identify a contour point based on one reference contour point according to a first method. The processor 105 of the object recognition apparatus 101 may identify one of two outermost (e.g., most protruding or farthest away from the center of the object) end points among the plurality of representative points as a first reference contour point. The processor 105 of the object recognition apparatus 101 may identify a first representative point, which is the representative point next to the first reference contour point, a second representative point, a third representative point, which is the representative point farther from the first reference contour point among the representative points on both sides of the second representative point, and a fourth representative point which is a representative point that is closer to the first reference contour point among the representative points on both sides of the second representative point. The processor 105 of the object recognition apparatus 101 may identify a contour point different from the first reference contour point based on the first reference contour point, the first representative point, the second representative point, and the third representative point, according to the first method.

The processor 105 of the object recognition apparatus 101 may identify that a contour point does not exist among the first representative point, the second representative point, the third representative point, and the fourth representative point based on the first reference contour point, the first representative point, the second representative point, and the third representative point, according to the first method. The processor 105 of the object recognition apparatus 101 may identify a fifth representative point, which is the representative point farther from the first reference contour point, among the representative points on both sides of the third representative point, and again identify a contour point different from the first reference contour point based on the first reference contour point, the first representative point, the third representative point, and the fifth representative point, according to the first method.

If at least one contour point that is different from the first reference contour point is identified through the first method, the processor 105 of the object recognition apparatus 101 may identify a contour point different from the plurality of contour points according to a second method. The processor 105 of the object recognition apparatus 101 may identify a second reference contour point and a third reference contour point, which is one of two contour points on both sides of the second reference contour point.

The processor 105 of the object recognition apparatus 101 may identify a sixth representative point that is not between the second reference contour point and the third reference contour point, and a seventh representative point that is a representative point farther from the second reference contour point among two representative points on both sides of the sixth representative point.

The processor 105 of the object recognition apparatus 101 may identify a contour point different from the second reference contour point and the third reference contour point based on the second reference contour point, the third reference contour point, the sixth representative point, and the seventh representative point, according to a second method.

The processor 105 of the object recognition apparatus 101 may identify that a contour point does not exist among the sixth representative point and the seventh representative point based on the second reference contour point, the third reference contour point, the sixth representative point and the seventh representative point, according to the second method. The processor 105 of the object recognition apparatus 101 may identify an eighth representative point, which is a representative point farther from the second reference contour point, among representative points on both sides of the seventh representative point, and identify the contour point different from the second reference contour point and the third reference contour point based on the first reference contour point, the second reference contour point, the seventh representative point, and the eighth representative point, according to the second method.

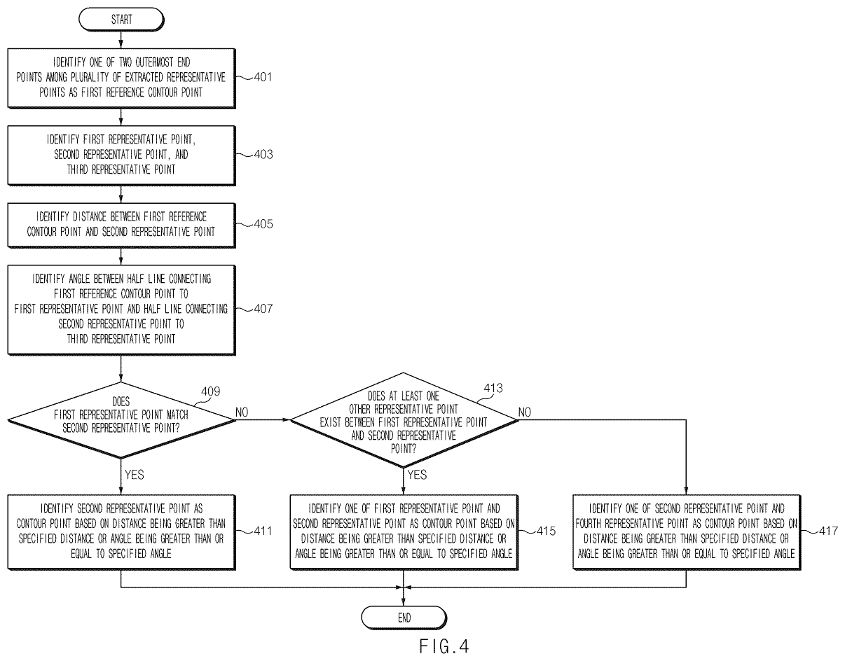

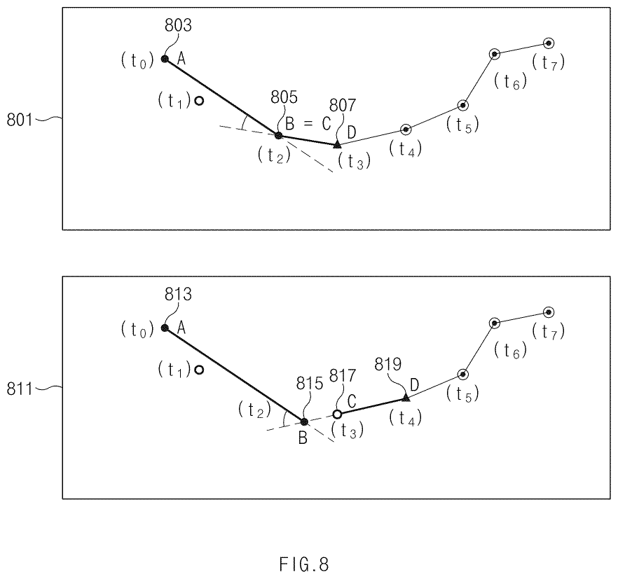

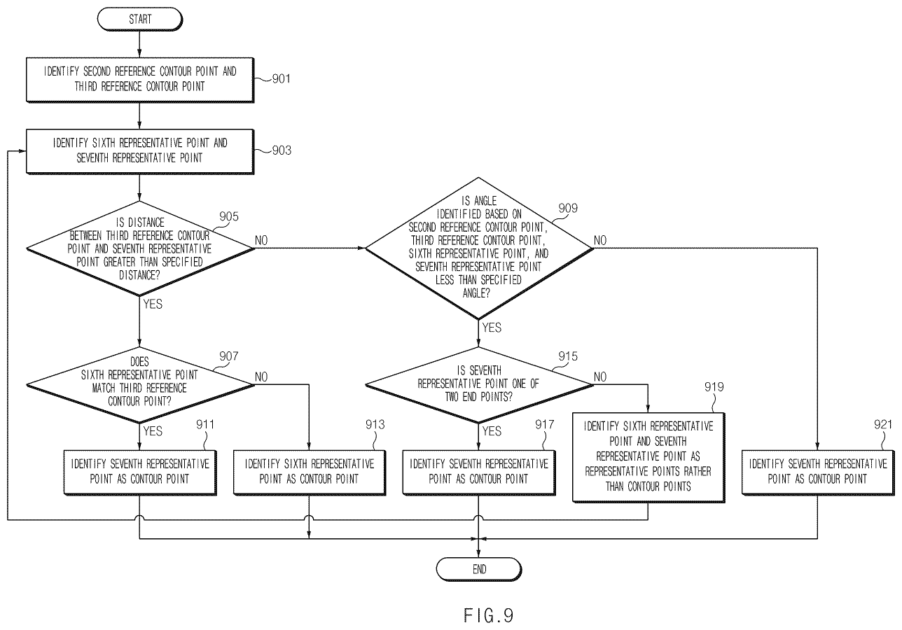

Hereinafter, the first method will be described with reference to FIGS. 4 to 7, and the second method will be described with reference to FIGS. 8 to 9.

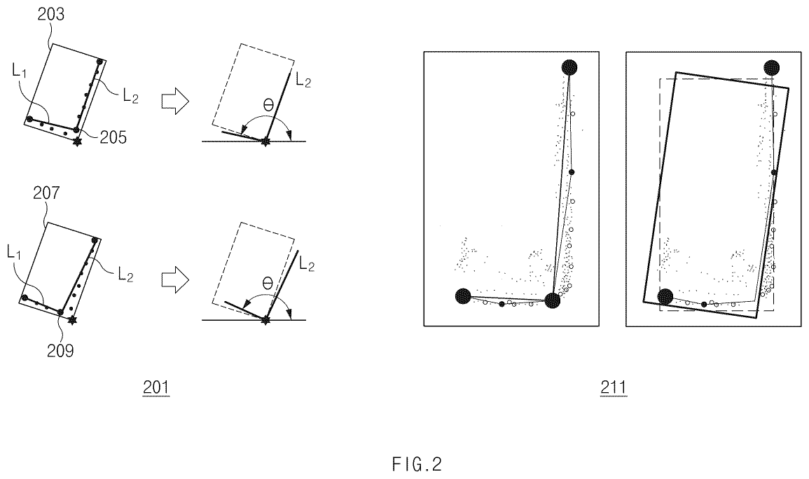

FIG. 2 shows an example showing a change in the moving direction of an object identified according to selection of contour points.

Referring to FIG. 2, a first screen 201 may display the moving direction of an object identified based on contour points. A first situation 203 of the first screen 201 may indicate the moving direction of an object identified based on contour points including a first contour point 205. A second situation 207 of the first screen 201 may indicate the moving direction of an object identified based on contour points including a second contour point 209. A second screen 211 may display the shape of an object identified based on contour points.

In the first screen 201, the identified representative points of the first situation 203 and the identified representative points of the second situation 207 may be the same. Even when the representative points are the same, the moving direction of the identified object may vary depending on which representative point is specified as a contour point by an existing object recognition apparatus. For example, in the first situation 203, when the object recognition apparatus identifies the first contour point 205 among a plurality of representative points as a contour point, the moving direction of the object may be identified based on the gradient of L2 of the first situation 203. For example, in the second situation 207, when the object recognition apparatus identifies a second contour point 209 among a plurality of representative points as a contour point, the moving direction of the object may be identified based on the gradient of L2 of the second situation 207. Referring to the first screen 201, the moving direction of the object identified in the first situation 203 and the moving direction of the object identified in the second situation 207 may be different.

Depending on which representative point is identified as a contour point, the accuracy of information on the object, including the moving direction of the object, may vary. In particular, the moving direction of the identified object may be significantly affected depending on which representative point is specified as the contour point among representative points located in a portion where a line connecting the representative points is bent. For example, the θ value, which is the degree to which a shape box of the first situation 203 is tilted, may be different from the θ value, which is the degree to which a shape box of the second situation 207 is tilted.

The processor of the object recognition apparatus may increase the number of contour points identified at the portion where the line connecting the representative points is bent, compared to the existing object recognition apparatus, thereby improving the accuracy of information on the object (e.g., the moving direction of an object) identified from the contour points.

The second screen 211 may display the shape of the identified object according to the specified contour points. Because the outer representative points among representative points of the portion where the line connecting the representative points is bent are not identified as contour points, the error in the information on the object identified from the contour points (e.g., the moving direction of the object) may be larger than the error in information on the object identified from the contour points including the contour point, which is an outer representative point.

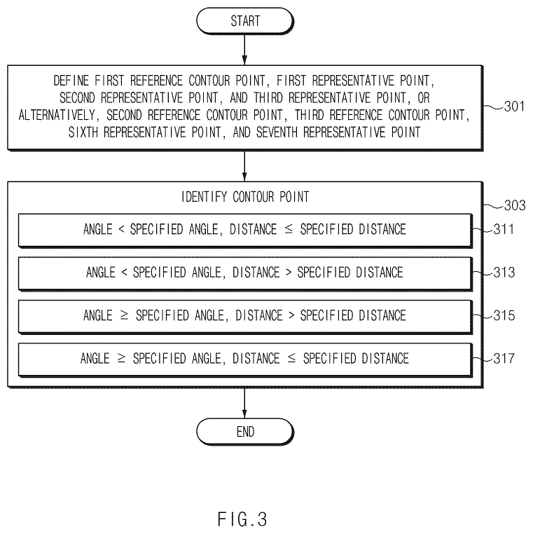

A flowchart of operation of the object recognition apparatus that identifies contour points to reduce error in information on the object identified from the contour points with be described with reference to FIG. 3.

FIG. 3 shows a flowchart of operation of an object recognition apparatus for identifying contour points according to a specified angle and a specified distance in the object recognition apparatus or an object recognition method.

Hereinafter, it is assumed that the object recognition apparatus 101 of FIG. 1 performs the process of FIG. 3. Additionally, in the description of FIG. 3, operations described as being performed by the apparatus may be understood as being controlled by the processor 105 of the object recognition apparatus 101.

Referring to FIG. 3, in the first operation 301, the processor of the object recognition apparatus may define a first reference contour point, a first representative point, a second representative point, and a third representative point, or alternatively, a second reference contour point, a third reference contour point, a sixth representative point, and a seventh representative point.

The processor of the object recognition apparatus may identify a first reference contour point, a first representative point, a second representative point, and a third representative point to identify a contour point through a first method using one reference contour point. Alternatively, the processor of the object recognition apparatus may identify a second reference contour point, a third reference contour point, a sixth representative point, and a seventh representative point to identify a contour point through a second method using two reference contour points.

In a second operation 303, the processor of the object recognition apparatus may identify a contour point. For example, in the first method, a first angle, which is a reference angle for identifying contour points, may include an angle between a half line (e.g., a ray) extending from the first reference contour point (e.g., an initial point) to the first representative point and a half line (e.g., a ray) extending from the second representative point (e.g., an initial point) to the third representative point. In the first method, a first distance, which is a reference distance for identifying contour points, may include a distance between the first reference contour point and the second representative point.

For example, in the second method, a second angle, which is a reference angle for identifying contour points, may include an angle between a half line (e.g., a ray) extending from the second reference contour point to the third representative point and a half line (e.g., a ray) extending from the sixth representative point to the seventh representative point. In the second method, the second distance, which is a reference distance for identifying contour points, may include a distance between the third reference contour point and the seventh representative point.

A first condition 311 may include a condition that an angle (e.g., first angle, second angle) is less than a specified angle (e.g., about 10°), and a distance (e.g., first distance, second distance) is less than or equal to a specified distance (e.g., approximately 3 m).

In the first method, when the first condition 311 is satisfied, the processor of the object recognition apparatus may identify that there is no contour point among the first representative point, the second representative point, and the fourth representative point. The fourth representative point may include a representative point closer to the first reference contour point among two representative points on both sides of the second representative point. The processor of the object recognition apparatus may identify the fifth representative point, which is the representative point farther from the first reference contour point, among two representative points on both sides of the third representative point. The processor of the object recognition apparatus may re-identify the contour point in the first method based on the first reference contour point, the first representative point, the third representative point, and the fifth representative point.

In the second method, when the first condition 311 is satisfied, the processor of the object recognition apparatus may identify that there is no contour point among the sixth representative point and the seventh representative point. The processor of the object recognition apparatus may identify the eighth representative point, which is the representative point farther from the second reference contour point, among two representative points on both the sides of seventh representative point. The processor of the object recognition apparatus may re-identify the contour point in the second method based on the second reference contour point, the third reference contour point, the seventh representative point, and the eighth representative point.

A second condition 313 may include a condition that an angle (e.g., first angle, second angle) is less than a specified angle (e.g., about 10°), and a distance (e.g., first distance, second distance) is greater than a specified distance (e.g., approximately 3 m). A third condition 315 may include a condition that an angle is greater than or equal to a specified angle and a distance is greater than the specified distance. A fourth condition 317 may include a condition that an angle is greater than or equal to the specified angle and a distance is less than or equal to the specified distance.

In the first method, when one of the second condition 313, the third condition 315, or the fourth condition 317 is satisfied, the processor of the object recognition apparatus may identify one of the first representative point, the second representative point, the third representative point, and fourth representative point as a contour point.

In the second method, when the first condition 311 is satisfied, and when one of the second condition 313, the third condition 315, or the fourth condition 317 is satisfied, the processor of the object recognition apparatus may identify one of the sixth representative point and the seventh representative point as a contour point.

The first method for identifying contour points will be described below with reference to FIGS. 4 to 7. The second method for identifying contour points with be described below with reference to FIGS. 8 to 9.

FIG. 4 shows a flowchart of operation of the object recognition apparatus for identifying a contour point through one reference contour point in the object recognition apparatus or the object recognition method.

Hereinafter, it is assumed that the object recognition apparatus 101 of FIG. 1 performs the process of FIG. 4. Additionally, in the description of FIG. 4, operations described as being performed by the apparatus may be understood as being controlled by the processor 105 of the object recognition apparatus 101.

Referring to FIG. 4, in a first operation 401, the processor of the object recognition apparatus may identify one of two outermost (e.g., most protruding or farthest away from the center of the object) end points among a plurality of extracted representative points as a first reference contour point. To extract a plurality of representative points, the processor of the object recognition apparatus may obtain points representing an object through a sensor (e.g., LIDAR). The processor of the object recognition apparatus may identify some or all of the outer points (e.g., surface points) among points obtained through the sensor (e.g., LIDAR) as a plurality of representative points.

In a second operation 403, the processor of the object recognition apparatus may identify a first representative point, a second representative point, and a third representative point. The first representative point may include a representative point next to the first reference contour point among the plurality of representative points. The second representative point may include a representative point that is not between the first reference contour point and the first representative point. The third representative point may include a representative point that is farther from the first reference contour point among two representative points on both sides of the second representative point.

In a third operation 405, the processor of the object recognition apparatus may identify a distance between the first reference contour point and the second representative point.

In a fourth operation 407, the processor of the object recognition apparatus may identify an angle between a half line (e.g., a ray) extending from the first reference contour point to the first representative point and a half line (e.g., a ray) extending from the second representative point to the third representative point. Using the angle, it is possible to identify how much a line segment connecting the second representative point and the third representative point is deviated from a line segment connecting the first reference contour point and the first representative point.

In a fifth operation 409, the processor of the object recognition apparatus may identify whether the first representative point matches and the second representative point. When the first representative point matches the second representative point, the processor of the object recognition apparatus may perform a sixth operation 411. When the first representative point does not match the second representative point, the processor of the object recognition apparatus may perform a seventh operation 413.

In the sixth operation 411, the processor of the object recognition apparatus may identify the second representative point as a contour point based on the distance being greater than or equal to a specified distance (e.g., about 3 m) or the angle being greater than or equal to a specified angle (e.g., about 10 degrees). This is because, when the distance is greater than or equal to the specified distance, the accuracy of information represented by the contour points may decrease as the distance between representative points increases. Also, this is because, when the angle is greater than the specified angle, the importance of the representative points may be high because the line segment connecting the representative points is bent. The processor of the object recognition apparatus may identify the second representative point as a contour point because there is no representative point that is closer to the first reference contour point than the second representative point.

In the seventh operation 413, the processor of the object recognition apparatus may identify whether at least one other representative point does not exist between the first representative point and the second representative point. When at least one other representative point exists between the first representative point and the second representative point, the processor of the object recognition apparatus may perform an eighth operation 415. When at least one other representative point does not exist between the first representative point and the second representative point, the processor of the object recognition apparatus may perform a ninth operation 417.

If the distance between the first reference contour point and the second representative point is greater than the specified distance, the processor of the object recognition apparatus may identify the first representative point as a contour point. This is because there is no representative point that is closer to the first reference contour point than the first representative point.

The processor of the object recognition apparatus may identify the second representative point as a contour point when an angle between a half line (e.g., a ray) extending from the first reference contour point to the first representative point and a half line (e.g., a ray) extending from the second representative point to the third representative point is greater than a specified angle (e.g., about 10°).

In the eighth operation 415, the processor of the object recognition apparatus may identify one of the first representative point and the second representative point as a contour point based on the distance being greater than the specified distance or the angle being greater than or equal to the specified angle.

If the distance between the first reference contour point and the second representative point is greater than the specified distance, the processor of the object recognition apparatus may identify the first representative point which is closer to the first reference contour point than the second representative point as a contour point.

The processor of the object recognition apparatus may identify the second representative point as a contour point when an angle between a half line (e.g., a ray) extending from the first reference contour point to the first representative point and a half line (e.g., a ray) extending from the second representative point to the third representative point is greater than a specified angle (e.g., about 10°).

In the ninth operation 417, the processor of the object recognition apparatus may identify one of the second representative point and the fourth representative point as a contour point based on the distance being greater than the specified distance or the angle being greater than or equal to the specified angle.

The fourth representative point may include a representative point closer to the first reference contour point among two representative points on both sides of the second representative point.

If the distance between the first reference contour point and the second representative point is greater than the specified distance, the processor of the object recognition apparatus may identify the fourth representative point which is closer to the first reference contour point than the second representative point as a contour point. This is because the fourth representative point is the farthest representative point from a reference contour point among representative points located within the specified distance.

The processor of the object recognition apparatus may identify the second representative point as a contour point when an angle between a half line (e.g., a ray) extending from the first reference contour point to the first representative point and a half line (e.g., a ray) extending from the second representative point to the third representative point is greater than a specified angle (e.g., about 10°). After one or more contour points are identified, a vehicle may be controlled based on the identified contour point(s) (e.g., evade an object, apply braking to avoid collision, etc.).

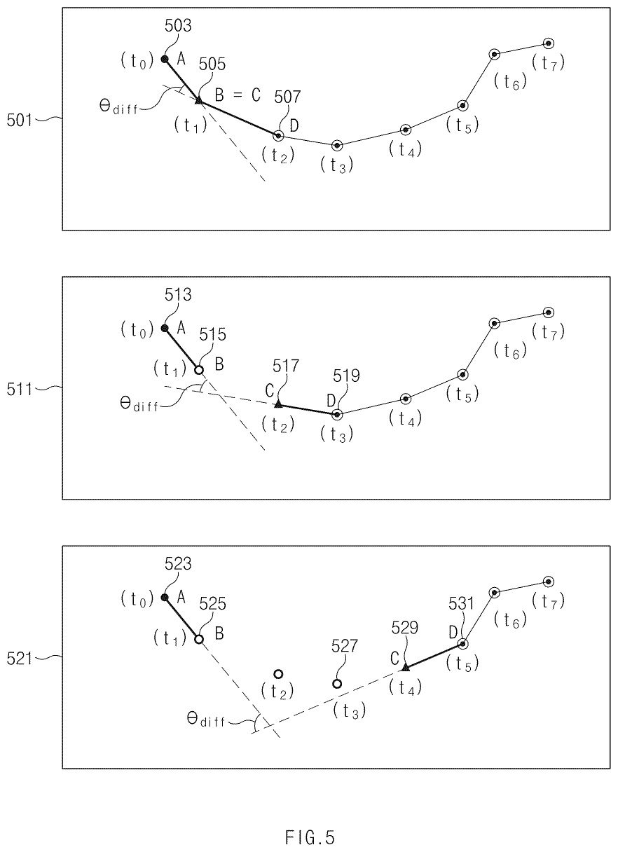

FIG. 5 shows examples of a reference contour point for identifying contour points and identified representative points in an object recognition apparatus or an object recognition method.

Referring to FIG. 5, the processor of the object recognition apparatus may identify representative points including some or all of outer points (e.g., surface points) among points obtained through the sensor (e.g., LIDAR). Representative points in a first example 501 may include a first point 503, a second point 505, and a third point 507. Representative points in a second example 511 may include a first point 513, a second point 515, a third point 517, and a fourth point 519. Representative points in a third example 521 may include a first point 523, a second point 525, a third point 527, a fourth point 529, and a fifth point 531.

The first example 501 shows a method of identifying contour points using one reference contour point when the first representative point and the second representative point match each other. The first point 503 may be identified as a first reference contour point. The second point 505 may be identified as a first representative point and a second representative point. The third point 507 may be identified as a third representative point.

The second example 511 shows a method of identifying contour points using one reference contour point when the first representative point and the second representative point are different, and at least one other representative point does not exist between the first representative point and the second representative point. The first point 513 may be identified as a first reference contour point. The second point 515 may be identified as a first representative point. The third point 517 may be identified as a second representative point. The fourth point 519 may be identified as a third representative point.

The third example 521 shows a method of identifying contour points using one reference contour point when the first representative point and the second representative point are different, and at least one other representative point exists between the first representative point and the second representative point. The first point 523 may be identified as a first reference contour point. The second point 525 may be identified as a first representative point. The third point 527 may be identified as a fourth representative point. The fourth point 529 may be identified as a second representative point. The fifth point 531 may be identified as a third representative point.

In the first example 501, when a distance between the first point 503, which is the first reference contour point, and the second point 505, which is the second representative point, is greater than a specified distance (e.g., about 3 m), the processor of the object recognition apparatus may identify the second point 505, which is the first representative point, as a contour point.

In the first example 501, when an angle between a half line (e.g., a ray) extending from the first point 503, which is the first reference contour point, to the second point 505, which is the first representative point, and a half line (e.g., a ray) extending from the second point 505, which is the second representative point, to the third point 507, which is the third representative point, is greater than or equal to a specified angle (e.g., about 10°), the processor of the object recognition apparatus may identify the second point 505, which is the first representative point and the second representative point, as a contour point.

In the first example 501, the processor of the object recognition apparatus may identify that there is no contour point among the second point 505, which is the first representative point and the second representative point, and the third point 507 which is the third representative point, based on identifying that a distance between the first point 503, which is the first reference contour point, and the second point 505, which is the second representative point, is less than or equal to the specified distance and the angle between the half line (e.g., a ray) extending from the first point 503, which is the first reference contour point, to the second point 505, which is the first representative point, and the half line (e.g., a ray) extending from the second point 505, which is the second representative point, to the third point 507, which is the third representative point, is less than the specified angle.

The processor of the object recognition apparatus may re-identify a contour point as in the second example 511, based on identifying that there is no contour point among the second point 505, which is the first representative point and the second representative point, and the third point 507, which is the third representative point.

In the second example 511, a distance between the first point 513, which is the first reference contour point, and the third point 517, which is the second representative point, is greater than a specified distance (e.g., about 3 m), the processor of the object recognition apparatus may identify the second point 515, which is the first representative point, as a contour point.

In the second example 511, when an angle between a half line (e.g., a ray) extending from the first point 513, which is the first reference contour point, to the second point 515, which is the first representative point, and a half line (e.g., a ray) extending from the third point 517, which is the second representative point, to the fourth point 507, which is the third representative point, is greater than or equal to a specified angle (e.g., about 10°), the processor of the object recognition apparatus may identify the third point 517, which is the second representative point, as a contour point.

In the second example 511, the processor of the object recognition apparatus may identify that there is no contour point among the second point 515, which is first the representative point, the third point 517 which is the second representative point, and the fourth point 519 which is the third representative point, based on identifying that a distance between the first point 513, which is the first reference contour point, and the third point 517, which is the second representative point, is less than or equal to the specified distance and the angle between the half line (e.g., a ray) extending from the first point 513, which is the first reference contour point, to the second point 515, which is the first representative point, and the half line (e.g., a ray) extending from the third point 517, which is the second representative point, to the fourth point 519, which is the third representative point, is less than the specified angle.

The processor of the object recognition apparatus may re-identify a contour point as in the third example 521, based on identifying that there is no contour point among the second point 515 which is the first representative point, the third point 517 which is the second representative point, and the fourth point 519, which is the third representative point.

In the third example 521, a distance between the first point 523 which is the first reference contour point, and the fourth point 529 which is the second representative point, is greater than a specified distance (e.g., about 3 m), the processor of the object recognition apparatus may identify the third point 527, which is the fourth representative point, as a contour point.

In the third example 521, when an angle between a half line (e.g., a ray) extending from the first point 523, which is the first reference contour point, to the second point 525, which is the first representative point, and a half line (e.g., a ray) extending from the fourth point 529 which is the second representative point, to the fifth point 531 which is the third representative point is greater than or equal to a specified angle (e.g., about 10°), the processor of the object recognition apparatus may identify the fourth point 529, which is the second representative point, as a contour point.

In the third example 521, the processor of the object recognition apparatus may identify that there is no contour point among the second point 525, which is the first representative point, the third point 527 which is the fourth representative point, the fourth point 529 which is the second representative point, and the fifth point 531 which is the third representative point based on identifying that a distance between the first point 523, which is the first reference contour point, and the fourth point 529, which is the second representative point, is less than or equal to the specified distance and the angle between the half line (e.g., a ray) extending from the first point 523, which is the first reference contour point, to the second point 525, which is the first representative point, and the half line (e.g., a ray) extending from the fourth point 529, which is the second representative point, to the fifth point 531, which is the third representative point, is less than the specified angle.

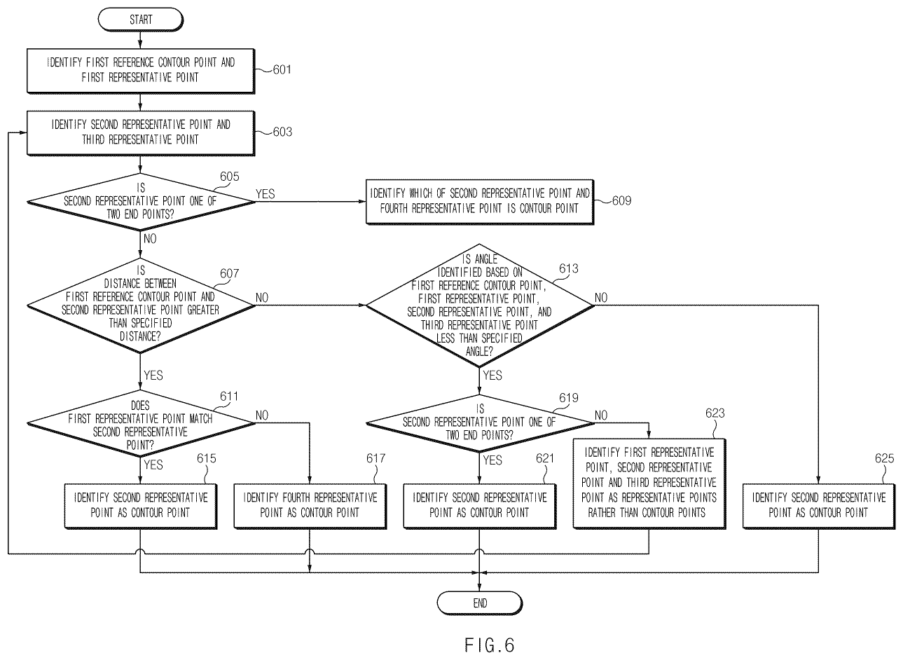

FIG. 6 shows a flowchart of operation of the object recognition apparatus for identifying a contour point through one reference contour point in the object recognition apparatus or the object recognition method.

Hereinafter, it is assumed that the object recognition apparatus 101 of FIG. 1 performs the process of FIG. 6. Additionally, in the description of FIG. 6, operations described as being performed by the apparatus may be understood as being controlled by the processor 105 of the object recognition apparatus 101.

Referring to FIG. 6, in a first operation 601, the processor of the object recognition apparatus may identify a first reference contour point and a first representative point. The first reference contour point may include one of two outermost (e.g., most protruding or farthest away from the center of the object) end points among the plurality of representative points. The first representative point may include a representative point next to the first reference contour point.

In a second operation 603, the processor of the object recognition apparatus may identify a second representative point and a third representative point. The second representative point may match the first representative point. The third representative point may include a representative point that is farther from the first reference contour point among two representative points on both sides of the second representative point.

In a third operation 605, the processor of the object recognition apparatus may identify whether the second representative point is one of the two end points. When the second representative point is one of the two end points, the processor of the object recognition apparatus may perform a fourth operation 607. When the second representative point is not one of the two endpoints, the processor of the object recognition apparatus may perform a fifth operation 609. In other words, when the second representative point is one of the two end points, the processor of the object recognition apparatus may identify a contour point through an exceptional operation because it is difficult to identify the third representative point.

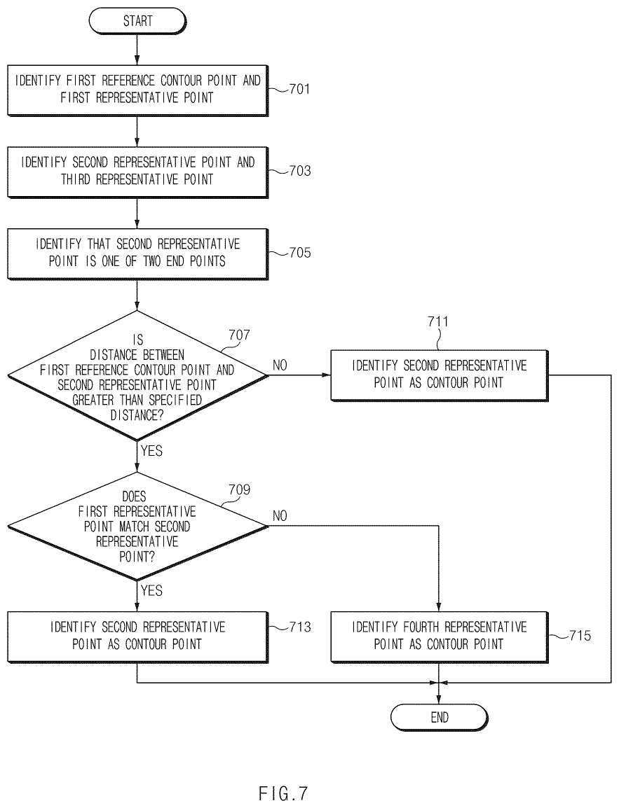

In a fifth operation 609, the processor of the object recognition apparatus may identify which of the second representative point and the fourth representative point is a contour point. Hereinafter, a method for identifying a contour point when the second representative point is one of two end points will be described with reference to FIG. 7.

In the fourth operation 607, the processor of the object recognition apparatus may identify whether a distance between the first reference contour point and the second representative point is greater than a specified distance. When the distance between the first reference contour point and the second representative point is greater than the specified distance, the processor of the object recognition apparatus may perform a sixth operation 611. When the distance between the first reference contour point and the second representative point does is not greater than the specified distance, the processor of the object recognition apparatus may perform a seventh operation 613.

This is because, in the case of identifying the second representative point as a contour point, the distance between the first reference contour point and a contour point identified based on the first reference contour point may be farther than the specified distance when the distance between the first reference contour point and the second representative point is greater than the specified distance. When the distance between contour points is farther than the specified distance, accuracy may decrease in case of comparing the shape of the object identified by the contour points with a precision map. Therefore, to ensure that the reliability of the contour line of an object identified by contour points is greater than a specified reliability value, the processor of the object recognition apparatus may identify the second representative point or the fourth representative point as a contour point when the distance between the first reference contour point and the second representative point is greater than a specified distance.

In a sixth operation 611, the processor of the object recognition apparatus may identify whether the first representative point and the second representative point match each other. When the first representative point and the second representative point match each other, the processor of the object recognition apparatus may identify an eighth operation 615. When the first representative point and the second representative point do not match each other, the processor of the object recognition apparatus may identify a ninth operation 617.

In the eighth operation 615, the processor of the object recognition apparatus may identify the second representative point as a contour point. When the first representative point and the second representative point match each other, there is no representative point that is closer to the first reference contour point than the second representative point.

In the ninth operation 617, the processor of the object recognition apparatus may identify the fourth representative point as a contour point. This is because the fourth representative point is the farthest representative point from a reference contour point among representative points located within the specified distance.

In the seventh operation 613, the processor of the object recognition apparatus may identify whether an angle identified based on the first reference contour point, the first representative point, the second representative point, and the third representative point is less than a specified angle. When the angle identified based on the first reference contour point, the first representative point, the second representative point, and the third representative point is less than the specified angle, the processor of the object recognition apparatus may perform a tenth operation 619. When the angle identified based on the first reference contour point, the first representative point, the second representative point, and the third representative point is greater than or equal to the specified angle, the processor of the object recognition apparatus may perform a thirteenth operation 625.

This is because the importance of the second representative point may be high because the second representative point is located in a portion where the angle of a line segment connecting the representative points is bent when the angle is greater than or equal to the specified angle. An angle identified based on the first reference contour point, the first representative point, the second representative point, and the third representative point may include an angle between a half line (e.g., a ray) extending from the first reference contour point to the first representative point and a half line (e.g., a ray) extending from the second representative point to the third representative point.

In the tenth operation 619, the processor of the object recognition apparatus may identify whether the second representative point is one of two end points. When the second representative point is one of the two end points, the processor of the object recognition apparatus may perform an eleventh operation 621. When the second representative point is not one of the two end points, the processor of the object recognition apparatus may perform a twelfth operation 623.

Even if the distance between the first reference contour point and the second representative point is less than or equal to the specified distance and the angle is less than the specified angle, the processor of the object recognition apparatus may identify the second representative point as a contour point when the second representative point is one of the two end points.

In the eleventh operation 621, the processor of the object recognition apparatus may identify the second representative point as a contour point.

In the twelfth operation 623, the processor of the object recognition apparatus may identify the second representative point and the third representative point as representative points rather than contour points. In other words, the processor of the object recognition apparatus may identify that there is no contour point among the first representative point, the second representative point, and the third representative point. Additionally, the processor of the object recognition apparatus may perform the second operation 603 again. It should be noted that, when performing the second operation 603 again, the processor of the object recognition apparatus may identify a previous third representative point as the second representative point and identify a representative point farther from the first reference contour point among two representative points on both sides of a previous second representative point, as the third representative point. In other words, the processor of the object recognition apparatus may identify a representative point farther from the first reference contour point among two representative points on both sides of the third representative point, as the fifth representative point, based on identifying that there is no contour point among the first representative point, the second representative point, and the fourth representative point. The processor of the object recognition apparatus may be configured to identify one of the second representative point and the fourth representative point as a contour point based on identifying that a distance between the first reference contour point and the third representative point is greater than the specified distance or an angle between the half line (e.g., a ray) extending from the first reference contour point to the first representative point and the half line (e.g., a ray) extending from the third representative point to the fifth representative point is greater than or equal to the specified angle.

In a thirteenth operation 625, the processor of the object recognition apparatus may identify the second representative point as a contour point.

FIG. 7 shows a flowchart of operation of the object recognition apparatus for identifying a specific representative point is a contour point through one reference contour point in the object recognition apparatus or the object recognition method.

Hereinafter, it is assumed that the object recognition apparatus 101 of FIG. 1 performs the process of FIG. 7. Additionally, in the description of FIG. 7, operations described as being performed by the apparatus may be understood as being controlled by the processor 105 of the object recognition apparatus 101.

Referring to FIG. 7, in a first operation 701, the processor of the object recognition apparatus may identify a first reference contour point and a first representative point. Because the first operation 701 is performed in the same manner as the first operation 601 of FIG. 6, an overlapping description will be omitted below.

In a second operation 703 processor of the object recognition apparatus may identify a second representative point and a third representative point. Because the second operation 703 is performed in the same manner as the second operation 603 of FIG. 6, an overlapping description will be omitted below.

In a third operation 705, the processor of the object recognition apparatus may identify whether the second representative point is one of the two end points. When the second representative point is one of two outermost (e.g., most protruding or farthest away from the center of the object) end points of a plurality of representative points, the processor of the object recognition apparatus may identify a contour point through an exceptional operation because it is difficult to identify the third representative point.

In the fourth operation 707, the processor of the object recognition apparatus may identify whether a distance between the first reference contour point and the second representative point is greater than a specified distance. When the distance between the first reference contour point and the second representative point is greater than the specified distance, the processor of the object recognition apparatus may perform a fifth operation 709. When the distance between the first reference contour point and the second representative point is less than or equal to the specified distance, the processor of the object recognition apparatus may perform a sixth operation 711. Because the fourth operation 707 is performed in the same manner as the fourth operation 607 of FIG. 6, an overlapping description will be omitted below.

In a sixth operation 711, the processor of the object recognition apparatus may identify the second representative point as a contour point. Because a half line (e.g., a ray) extending from the second representative point to the third representative point is unable to be identified when the second representative point is one of the two outermost (e.g., most protruding or farthest away from the center of the object) end points of the plurality of representative points, an angle between the half line (e.g., a ray) extending from the first reference contour point to the first representative point and the half line (e.g., ray) extending from the second representative point to the third representative point may not be identified. Accordingly, the processor of the object recognition apparatus may identify the second representative point as a contour point, even when the distance between the first reference contour point and the second representative point is not greater than the specified distance, without determining an angle condition.

In a fifth operation 709 the processor of the object recognition apparatus may identify whether the first representative point and the second representative point match each other. When the first representative point matches the second representative point, the processor of the object recognition apparatus may perform a seventh operation 713. When the first representative point does not match the second representative point, the processor of the object recognition apparatus may perform an eighth operation 715. Because the fifth operation 709 is performed in the same manner as the sixth operation 611 of FIG. 6, an overlapping description will be omitted below.

In the seventh operation 713, the processor of the object recognition apparatus may identify the second representative point as a contour point. Because the seventh operation 713 is performed in the same manner as the eighth operation 615 of FIG. 6, an overlapping description will be omitted below.

In the eighth operation 715, the processor of the object recognition apparatus may identify the fourth representative point as a contour point. Because the eighth operation 715 is performed in the same manner as the ninth operation 617 of FIG. 6, an overlapping description will be omitted below.

FIG. 8 shows examples of a plurality of reference contour points for identifying contour points and identified representative points in an object recognition apparatus or an object recognition method.

Referring to FIG. 8, the processor of the object recognition apparatus may identify representative points including some or all of the outer points (e.g., surface points) among points obtained through the sensor (e.g., LIDAR). Representative points in a first example 801 may include a first point 803, a second point 805, and a third point 807. Representative points in a second example 811 may include a first point 813, a second point 815, a third point 817, and a fourth point 819.

The first example 801 shows a method of identifying contour points using two reference contour points when a third reference contour point and a sixth representative point match each other. The first point 803 may be identified as a second reference contour point. The second point 805 may be identified as a third reference contour point and a sixth representative point. The third point 807 may be identified as a seventh representative point.

The second example 811 shows a method of identifying contour points using two reference contour points when a third reference contour point and a sixth representative point do not match each other. The first point 813 may be identified as a second reference contour point. The second point 815 may be identified as a third reference contour point. The third point 817 may be identified as a sixth representative point. The fourth point 819 may be identified as a seventh representative point.

In the first example 801, a distance between the second point 805, which is the third reference contour point, and the third point 807, which is the seventh representative point, is greater than a specified distance (e.g., about 3 m), the processor of the object recognition apparatus may identify the third point 807, which is the seventh representative point, as a contour point.

In the first example 801, when an angle between a half line (e.g., a ray) extending from the first point 803, which is the second reference contour point, to the second point 805, which is the third reference contour point, and a half line (e.g., a ray) extending from the second point 805 which is the sixth representative point, to the third point 807 which is the seventh representative point is greater than or equal to a specified angle (e.g., about 10°), the processor of the object recognition apparatus may identify the third point 807, which is the seventh representative point, as a contour point.

In the first example 801, the processor of the object recognition apparatus may identify that there is no contour point among the second point 805, which is the sixth representative point, and the third point 807 which is the seventh representative point, based on identifying that a distance between the second point 805, which is the third reference contour point, and the third point 807, which is the seventh representative point, is less than or equal to the specified distance and the angle between the half line (e.g., a ray) extending from the first point 803, which is the second reference contour point, to the second point 805, which is the third reference contour point, and the half line (e.g., a ray) extending from the second point 805, which is the sixth representative point, to the third point 807, which is the seventh representative point, is less than the specified angle.

The processor of the object recognition apparatus may re-identify a contour point as in the second example 811, based on identifying that there is no contour point among the second point 805, which is the sixth representative point, and the third point 807, which is the seventh representative point.

In the second example 811, a distance between the second point 815, which is the third reference contour point, and the fourth point 819, which is the seventh representative point, is greater than a specified distance (e.g., about 3 m), the processor of the object recognition apparatus may identify the third point 817, which is the sixth representative point, as a contour point.

In the second example 811, when an angle between a half line (e.g., a ray) extending from the first point 813, which is the second reference contour point, to the second point 815, which is the third reference contour point, and a half line (e.g., a ray) extending from the third point 817 which is the sixth representative point, to the fourth point 819 which is the seventh representative point is greater than or equal to a specified angle (e.g., about 10°), the processor of the object recognition apparatus may identify the fourth point 819, which is the seventh representative point, as a contour point.

In the second example 811, the processor of the object recognition apparatus may identify that there is no contour point among the third point 817, which is the sixth representative point, and the fourth point 819 which is the seventh representative point, based on identifying that a distance between the second point 815, which is the third reference contour point, and the fourth point 819, which is the seventh representative point, is less than or equal to the specified distance and the angle between the half line (e.g., a ray) extending from the first point 813, which is the second reference contour point, to the second point 815, which is the third reference contour point, and the half line (e.g., a ray) extending from the third point 817, which is the sixth representative point, to the fourth point 819, which is the seventh representative point, is less than the specified angle.

FIG. 9 shows a flowchart of operation of the object recognition apparatus for identifying a contour point through a plurality of reference contour points in the object recognition apparatus or the object recognition method.

Hereinafter, it is assumed that the object recognition apparatus 101 of FIG. 1 performs the process of FIG. 9. Additionally, in the description of FIG. 9, operations described as being performed by the apparatus may be understood as being controlled by the processor 105 of the object recognition apparatus 101.

Referring to FIG. 9, in a first operation 901, the processor of the object recognition apparatus may identify a second reference contour point and a third reference contour point. The second reference contour point may include one contour point among a plurality of representative points. The third reference contour point may include one of two contour points on both sides of the second reference contour point.

In a second operation 903, the processor of the object recognition apparatus may identify a sixth representative point and a seventh representative point. The sixth representative point and the seventh representative point may not be located between the second reference contour point and the third reference contour point. The seventh representative point may include a representative point that is farther from the second reference contour point among two representative points on both sides of the sixth representative point.

In the third operation 905 the processor of the object recognition apparatus may identify whether a distance between the third reference contour point and the seventh representative point is greater than a specified distance. When the distance between the third reference contour point and the seventh representative point is greater than the specified distance, the processor of the object recognition apparatus may perform a fourth operation 907. When the distance between the third reference contour point and the seventh representative point is less than or equal to the specified distance, the processor of the object recognition apparatus may perform a fifth operation 909.

This is because, in the case of identifying the seventh representative point as a contour point, the distance between the third reference contour point and a contour point identified based on the second reference contour point and the third reference contour point may be farther than the specified distance when the distance between the third reference contour point and the seventh representative point is greater than the specified distance. When the distance between contour points is farther than the specified distance, accuracy may decrease in case of comparing the shape of the object identified by the contour points with a precision map. Therefore, to secure reliability greater than a specified reliability value for the contour line of an object identified by contour points, a distance between the third contour point and the seventh representative point may be considered in identifying contour points.

In a fourth operation 907, the processor of the object recognition apparatus may identify whether the sixth representative point and the third reference contour point match each other. When the sixth representative point and the third reference contour point match each other, the processor of the object recognition apparatus may perform a sixth operation 911. When the sixth representative point and the third reference contour point do not match each other, the processor of the object recognition apparatus may perform a seventh operation 913.

In the fifth operation 909, the processor of the object recognition apparatus may identify whether an angle identified based on the second reference contour point, the third reference contour point, the sixth representative point, and the seventh representative point is less than a specified angle. When the angle identified based on the second reference contour point, the third reference contour point, the sixth representative point, and the seventh representative point is less than the specified angle, the processor of the object recognition apparatus may perform an eighth operation 915. When the angle identified based on the second reference contour point, the reference third contour point, the sixth representative point, and the seventh representative point is greater than or equal to the specified angle, the processor of the object recognition apparatus may perform a ninth operation 921.

An angle identified based on the second reference contour point, the third reference contour point, the sixth representative point, and the seventh representative point may include an angle between a half line (e.g., a ray) extending from the second reference contour point to the third reference contour point and a half line (e.g., a ray) extending from the sixth representative point to the seventh representative point. This is because the importance of the seventh representative point may be high because the seventh representative point is located in a portion where the angle of a line segment connecting the representative points is bent when the angle is greater than or equal to the specified angle. Accordingly, the processor of the object recognition apparatus may consider the angle identified based on the second reference contour point, the third reference contour point, the sixth representative point, and the seventh representative point when identifying contour points.

In the eighth operation 915, the processor of the object recognition apparatus may identify whether the seventh representative point is one of two end points. When the seventh representative point is one of the two end points, the processor of the object recognition apparatus may perform a tenth operation 917. When the seventh representative point is not one of the two end points, the processor of the object recognition apparatus may perform an eleventh operation 919.

Even if the distance between the third reference contour point and the seventh representative point is less than or equal to the specified distance and the angle is less than the specified angle, the processor of the object recognition apparatus may identify the seventh representative point as a contour point when the seventh representative point is one of the two end points.

In the tenth operation 917, the processor of the object recognition apparatus may identify the seventh representative point as a contour point.

In the eleventh operation 919, the processor of the object recognition apparatus may identify the sixth representative point and the seventh representative point as representative points rather than contour points. In addition, the processor of the object recognition apparatus may perform the second operation 903 again.

The processor of the object recognition apparatus may identify a representative point farther from the second reference contour point among two representative points on both sides of the seventh representative point, as the eighth representative point, based on identifying that there is no contour point among the sixth representative point and the seventh representative point. The processor of the object recognition apparatus may be configured to identify one of the sixth representative point and the seventh representative point as a contour point based on identifying that a distance between the third reference contour point and the seventh representative point is greater than the specified distance or an angle between the half line (e.g., a ray) extending from the second reference contour point to the third reference contour point and the half line (e.g., a ray) extending from the sixth representative point and the seventh representative point is greater than or equal to the specified angle.

In the ninth operation 921, the processor of the object recognition apparatus may identify the seventh representative point as a contour point.

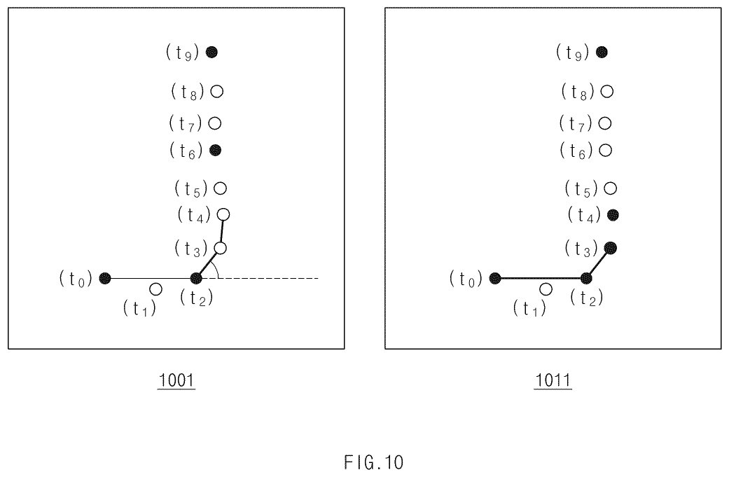

FIG. 10 shows examples of identified contour points in an object recognition apparatus or an object recognition method.

Referring to FIG. 10, a first screen 1001 may display representative points and contour points identified by an existing object recognition apparatus. A second screen 1011 may display representative points and contour points identified by an object recognition apparatus. Empty dots in the first screen 1001 and the second screen 1011 may be representative points that are not identified as contour points. Solid dots in the first screen 1001 and the second screen 1011 may be representative points identified as contour points.

In the first screen 1001, when a contour point is identified by the existing object recognition apparatus, a comparison of the angle between the first reference line segment and the subsequent reference line segment to identify the contour point may not be performed.

In the second screen 1011, because the angle between the identified contour points and the representative point on which identification of whether the representative point is a contour point is to be performed may be considered when a contour point is identified by the object recognition apparatus, representative points of which angle is changed by more than a specified angle may be identified as contour points.

Therefore, compared to the existing object recognition apparatus, the object recognition apparatus may identify representative points whose angles change by more than a specified angle as contour points.

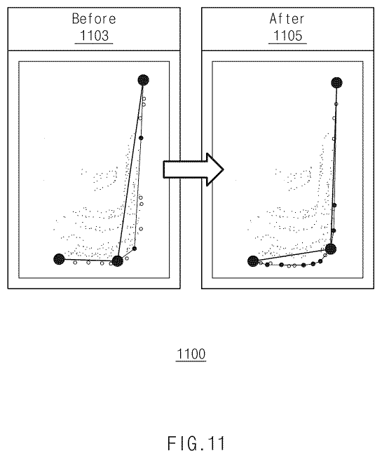

FIG. 11 shows an example of reliability for indicating the accuracy of identified contour points in an object recognition apparatus or object recognition method.

Referring to FIG. 11, a screen 1100 may display a first distribution 1103 of contour points identified by an existing object recognition apparatus and a second distribution 1105 of contour points identified by an object recognition apparatus.

In the first distribution 1103, the reliability of contour points identified by the existing object recognition apparatus may be about 66.5. In the second distribution 1105, the reliability of contour points identified by the object recognition apparatus may be about 71.5. Accordingly, the reliability of contour points identified by the object recognition apparatus may be higher than the reliability of contour points identified by the existing object recognition apparatus.

The processor of the object recognition apparatus may calculate the reliability of contour points based on at least one of a first variable value, a second variable value, a third variable value, a fourth variable value, a fifth variable value, or any combination thereof.

The first end point and the second end point may correspond to the two outermost (e.g., most protruding or farthest away from the center of the object) end points among contour points. A peak point may include a contour point located farthest from a line segment connecting the first end point and the second end point among contour points.

The first line segment may include a line segment connecting the first end point and the peak point. The second line segment may include a line segment connecting the second endpoint and the peak point.

The reliability of the contour points may be identified based on the sum of at least one of a value obtained by multiplying the first variable value by a weight, a value obtained by multiplying the second variable value by a weight, a value obtained by multiplying the third variable value by a weight, a value obtained by multiplying the fourth variable value by a weight, a value obtained by multiplying the fifth variable value by a weight, or any combination thereof.

The first variable value may include a value identified based on the variance of contour points. For example, the processor of the object recognition apparatus may identify the first variable value based on a variance value for distances between the first line segment and contour points near the first line segment, and a variance value for distances between the second line segment and contour points near the second line segment.

The second variable value may be identified based on the distribution of contour points for the first line segment and the distribution of contour points for the second line segment.

For example, the distribution of contour points for the first line segment may include identification as to whether all contour points near the first line segment are distributed in only one direction, with respect to the first line segment. The distribution of contour points for the second line segment may include identification as to whether all contour points near the second line segment are distributed in only one direction.

The third variable value may be identified based on the average of the angles of the contour points. The angle of each contour point may include an angle between a half line (e.g., a ray) extending from a specific contour point to one of contour points on both sides of the specific contour point, and a half line (e.g., a ray) extending from a specific contour point to the other of the contour points on both sides of the specific contour point.

The fourth variable value may be identified based on the distribution of contour points for the first line segment and the distribution of contour points for the second line segment.

The fifth variable value may be identified based on the ratio of the length in one direction of a contour box containing contour points included in a specific layer and the length in one direction of a cluster box containing contour points included in a plurality of layers.

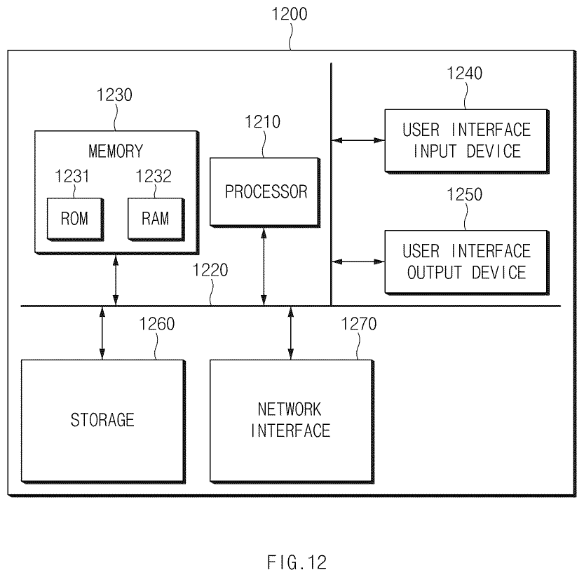

FIG. 12 illustrates a computing system for an object recognition apparatus or an object recognition method.

Referring to FIG. 12, a computing system 1200 may include at least one processor 1210, a memory 1230, a user interface input device 1240, a user interface output device 1250, storage 1260, and a network interface 1270, which are connected with each other via a bus 1220.

The processor 1210 may be a central processing unit (CPU) or a semiconductor device that processes instructions stored in the memory 1230 and/or the storage 1260. The memory 1230 and the storage 1260 may include various types of volatile or non-volatile storage media. For example, the memory 1230 may include a ROM (Read Only Memory) 1231 and a RAM (Random Access Memory) 1232.

Thus, the operations of the method or the algorithm described in connection with one or more example embodiments disclosed herein may be embodied directly in hardware or a software module executed by the processor 1210, or in a combination thereof. The software module may reside on a storage medium (that is, the memory 1230 and/or the storage 1260) such as a RAM, a flash memory, a ROM, an EPROM, an EEPROM, a register, a hard disk, a removable disk, and a CD-ROM.

The exemplary storage medium may be coupled to the processor 1210, and the processor 1210 may read information out of the storage medium and may record information in the storage medium. Alternatively, the storage medium may be integrated with the processor 1210. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure, and various modifications and variations may be made without departing from the essential characteristics of the present disclosure by those skilled in the art to which the present disclosure pertains.

Accordingly, the one or more example embodiment disclosed in the present disclosure is not intended to limit the technical idea of the present disclosure but to describe the present disclosure, and the scope of the technical idea of the present disclosure is not limited by the example embodiments. The scope of protection of the present disclosure should be interpreted by the following claims, and all technical ideas within the scope equivalent thereto should be construed as being included in the scope of the present disclosure.

The present technology can reduce the amount of computations required for object recognition by identifying some of the representative points obtained through a sensor (e.g., LIDAR) as contour points.

Further, the present technology can increase the accuracy of the contour point representing the object by using angle conditions and length conditions.

Further, the present technology increases the accuracy of representing an object compared to the number of contour points by increasing the spacing between contour points of portions where the contour of the object does not change and reducing the spacing between contour points of portions where the contour of the object changes.

Further, the present technology can increase the accuracy of the moving direction of the identified object by increasing the accuracy of representing the object through contour points.

Further, the present technology can enhance user experience by increasing the accuracy of contour points representing an object.

Further, the present technology can reduce the risk of accidents in autonomous vehicles or vehicles with activated driving assistance devices by increasing the accuracy of the moving direction of the identified object.

Further, the present technology can improve the performance of autonomous driving or driving assistance devices by increasing the accuracy of the moving direction of the identified object.

In addition, various effects may be provided that are directly or indirectly understood through the disclosure.

Hereinabove, although the present disclosure has been described with reference to one or more example embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An object recognition apparatus comprising:
a sensor; and
a processor configured to:
extract, among a plurality of points that are obtained via the sensor and represent an object, a plurality of representative points comprising at least part of surface points of the object;
determine a first reference contour point, which is one of two outermost end points of the plurality of representative points;
determine a first representative point, which is adjacent to the first reference contour point among the plurality of representative points;
determine, among the plurality of representative points, a second representative point different from the first reference contour point;
determine a third representative point, which is a point that is, of two representative points on both sides of the second representative point, farther away from the first reference contour point;
determine a first distance between the first reference contour point and the second representative point;
determine a first angle between a first ray extending from the first reference contour point to the first representative point and a second ray extending from the second representative point to the third representative point;
determine, as a contour point, one of:
the second representative point, based on the first representative point matching the second representative point, and further based on determining that the first distance is greater than a threshold distance or the first angle is greater than or equal to a threshold angle,
one of the first representative point or the second representative point, based on the first representative point not matching the second representative point, further based on determining that the first distance is greater than the threshold distance or the first angle is greater than or equal to the threshold angle, and further based on determining that no other representative point, among the plurality of representative points, exists between the first representative point and the second representative point, or
one of the second representative point or a fourth representative point, based on the first representative point not matching the second representative point, further based on determining that at least one other representative point among the plurality of representative points exists between the first representative point and the second representative point, and further based on determining that the first distance is greater than the threshold distance or the first angle is greater than or equal to the threshold angle, wherein the fourth representative point is a point that is, of the two representative points on both sides of the second representative point, closer to the first reference contour point; and
control a vehicle based on the contour point.

2. The object recognition apparatus of claim 1, wherein the processor is further configured to determine, as the contour point, one of:
the second representative point, based on determining that the first distance is greater than the threshold distance, and further based on the first representative point matching the second representative point,
the first representative point, based on determining that the first distance is greater than the threshold distance, and further based on determining that no other representative point exists between the first representative point and the second representative point, or
the fourth representative point, based on determining that the first distance is greater than the threshold distance, and further based on determining that the at least one other representative point exists between the first representative point and the second representative point.

3. The object recognition apparatus of claim 1, wherein the processor is further configured to determine one of:
the second representative point as the contour point based on the second representative point being one of the two outermost end points, and further based on determining that the first distance is less than or equal to the threshold distance and the first angle is less than the threshold angle, or
the contour point not existing among the first representative point, the second representative point, and the fourth representative point, based on the second representative point not being one of the two outermost end points.

4. The object recognition apparatus of claim 1, wherein the processor is further configured to determine the second representative point as the contour point based on determining that the first distance is less than or equal to the threshold distance and the first angle is greater than or equal to the threshold angle.

5. The object recognition apparatus of claim 1, wherein the processor is further configured to determine, as the contour point, one of:
the second representative point, based on determining that the second representative point is one of the two outermost end points, further based on determining that the first distance is greater than the threshold distance, and further based on the first representative point matching the second representative point,
the first representative point, based on determining that the second representative point is one of the two outermost end points, further based on determining that the first distance is greater than the threshold distance, further based on the first representative point not matching the second representative point, and further based on determining that there is no other representative point, among the plurality of representative points, exists between the first representative point and the second representative point, or
the fourth representative point, based on determining that the second representative point is one of the two outermost end points, further based on determining that the first distance is greater than the threshold distance, further based on the first representative point not matching the second representative point, and further based on determining that at least one other representative point among the plurality of representative points exists between the first representative point and the second representative point.

6. The object recognition apparatus of claim 1, wherein the processor is further configured to:
determine the second representative point as the contour point based on determining that the second representative point is one of the two outermost end points, and further based on determining that the first distance is less than or equal to the threshold distance.

7. The object recognition apparatus of claim 1, wherein the processor is further configured to:
determine a fifth representative point, which is a point that is, of two representative points on both sides of the third representative point, farther away from the first reference contour point, based on determining that the contour point does not exist among the first representative point, the second representative point, and the fourth representative point; and
determine one of the second representative point or the third representative point as the contour point, based on determining that a second distance between the first reference contour point and the third representative point is greater than the threshold distance or a second angle between the first ray and a third ray extending from the third representative point to the fifth representative point is greater than or equal to the threshold angle.

8. The object recognition apparatus of claim 1, wherein the processor is further configured to:
determine a second reference contour point and a third reference contour point, wherein the third reference contour point is one of two contour points on both sides of the second reference contour point;
determine a sixth representative point that is not between the second reference contour point and the third reference contour point;
determine a seventh representative point, which is a point that is, of two representative points on both sides of the sixth representative point, farther away from the second reference contour point;
determine a second distance between the third reference contour point and the seventh representative point;
determine a second angle between a third ray extending from the second reference contour point to the third reference contour point and a fourth ray extending from the sixth representative point to the seventh representative point; and
determine, as the contour point, one of:
the seventh representative point, based on determining that the second distance is greater than the threshold distance or the second angle is greater than or equal to the threshold angle, and further based on the third reference contour point matching the sixth representative point; or
one of the sixth representative point or the seventh representative point, based on determining that the second distance is greater than the threshold distance or the second angle is greater than or equal to the threshold angle, and further based on the third reference contour point not matching the sixth representative point.

9. The object recognition apparatus of claim 8, wherein the processor is further configured to determine, as the contour point, one of:
the seventh representative point, based on the second distance being greater than the threshold distance, and further based on the third reference contour point matching the sixth representative point, or
the sixth representative point, based on the second distance being greater than the threshold distance, and further based on the third reference contour point not matching the sixth representative point.

10. The object recognition apparatus of claim 8, wherein the processor is further configured to:
determine whether the seventh representative point is one of the two outermost end points, based on determining that the second distance is less than or equal to the threshold distance and the second angle is less than the threshold angle; and
determine one of:
the seventh representative point as the contour point, based on the seventh representative point being one of the two outermost end points, or
the contour point not existing among the sixth representative point and the seventh representative point, based on the seventh representative point not being one of the two outermost end points.

11. The object recognition apparatus of claim 8, wherein the processor is further configured to determine the seventh representative point as the contour point based on determining that the second distance is less than or equal to the threshold distance and the second angle is greater than or equal to the threshold angle.

12. The object recognition apparatus of claim 8, wherein the processor is further configured to:
determine an eighth representative point, which is a point that is, of two representative points on both sides of the seventh representative point, farther away from the second reference contour point, based on determining that the contour point does not exist among the sixth representative point and the seventh representative point; and
determine one of the seventh representative point and the eighth representative point as the contour point, based on determining that a third distance between the third reference contour point and the eighth representative point is greater than the threshold distance or a third angle between the third ray and a fifth ray extending from the seventh representative point to the eighth representative point is greater than or equal to the threshold angle.

13. An object recognition method comprising:
extracting, among a plurality of points that are obtained via a sensor and represent an object, a plurality of representative points comprising at least part of surface points of the object;
determining a first reference contour point, which is one of two outermost end points of the plurality of representative points;
determining a first representative point, which is adjacent to the first reference contour point among the plurality of representative points;
determining, among the plurality of representative points, a second representative point different from the first reference contour point;
determining a third representative point, which is a point that is, of two representative points on both sides of the second representative point, farther away from the first reference contour point;
determining a first distance between the first reference contour point and the second representative point;
determining a first angle between a first ray extending from the first reference contour point the first representative point and a second ray extending from the second representative point to the third representative point;
determining, as a contour point, one of:
the second representative point, based on the first representative point matching the second representative point, and further based on determining that the first distance is greater than a threshold distance or the first angle is greater than or equal to a threshold angle,
one of the first representative point or the second representative point, based on the first representative point not matching the second representative point, further based on determining that the first distance is greater than the threshold distance or the first angle is greater than or equal to the threshold angle, and further based on determining that no other representative point, among the plurality of representative points, exists between the first representative point and the second representative point, or
one of the second representative point or a fourth representative point, based on the first representative point not matching the second representative point, further based on determining that at least one other representative point among the plurality of representative points exists between the first representative point and the second representative point, and further based on determining that the first distance is greater than the threshold distance or the first angle is greater than or equal to the threshold angle, wherein the fourth representative point is a point that is, of the two representative points on both sides of the second representative point, closer to the first reference contour point; and
controlling a vehicle based on the contour point.

14. The object recognition method of claim 13, further comprising determining, as the contour point, one of:
the second representative point, based on determining that the first distance is greater than the threshold distance and further based on the first representative point matching the second representative point,
the first representative point, based on determining that the first distance is greater than the threshold distance, further based on determining that no other representative point exists between the first representative point and the second representative point, or
the fourth representative point, based on determining that the first distance is greater than the threshold distance and further based on determining that the at least one other representative point exists between the first representative point and the second representative point.

15. The object recognition method of claim 13, further comprising determining one of:
the second representative point as the contour point based on the second representative point being one of the two outermost end points and further based on determining that the first distance is less than or equal to the threshold distance and the first angle is less than the threshold angle; or
the contour point not existing among the first representative point, the second representative point, and the fourth representative point, based on the second representative point not being one of the two outermost end points.

16. The object recognition method of claim 13, further comprising:
determining the second representative point as the contour point based on determining that the first distance is less than or equal to the threshold distance and the first angle is greater than or equal to the threshold angle.

17. The object recognition method of claim 13, further comprising determining, as the contour point, one of:
the second representative point, based on determining that the second representative point is one of the two outermost end points, further based on determining that the first distance is greater than the threshold distance, and further based on the first representative point matching the second representative point,
the first representative point, based on determining that the second representative point is one of the two outermost end points, further based on determining that the first distance is greater than the threshold distance, further based on the first representative point not matching the second representative point, and further based on determining that there is no other representative point, among the plurality of representative points, exists between the first representative point and the second representative point, or
the fourth representative point, based on determining that the second representative point is one of the two outermost end points, further based on determining that the first distance is greater than the threshold distance, further based on the first representative point not matching the second representative point, and further based on determining that at least one other representative point among the plurality of representative points exists between the first representative point and the second representative point.

18. The object recognition method of claim 13, further comprising:
determining the second representative point as the contour point based on determining that the second representative point is one of the two outermost end points, and further based on determining that the first distance is less than or equal to the threshold distance.

19. The object recognition method of claim 13, further comprising:
determining a fifth representative point, which is a point that is, of two representative points on both sides of the third representative point, farther away from the first reference contour point, based on determining that the contour point does not exist among the first representative point, the second representative point, and the fourth representative point; and
determining one of the second representative point or the third representative point as the contour point, based on determining that a second distance between the first reference contour point and the third representative point is greater than the threshold distance or a second angle between the first ray and a third ray extending from the third representative point to the fifth representative point is greater than or equal to the threshold angle.

20. The object recognition method of claim 13, further comprising:
determining a second reference contour point and a third reference contour point, wherein the third reference contour point is one of two contour points on both sides of the second reference contour point;
determining a sixth representative point that is not between the second reference contour point and the third reference contour point;
determining a seventh representative point, which is a point that is, of two representative points on both sides of the sixth representative point, farther away from the second reference contour point;
determining a second distance between the third reference contour point and the seventh representative point;
determining a second angle between a third ray extending from the second reference contour point to the third reference contour point and a fourth ray extending from the sixth representative point to the seventh representative point; and
determining, as the contour point, one of:
the seventh representative point, based on determining that the second distance is greater than the threshold distance or the second angle is greater than or equal to the threshold angle, and further based on the third reference contour point matching the sixth representative point; or
one of the sixth representative point or the seventh representative point, based on determining that the second distance is greater than the threshold distance or the second angle is greater than or equal to the threshold angle, and further based on the third reference contour point not matching the sixth representative point.
